(19) United States
(12) Patent Application Publication
(10) Pub. No.: US 2016/0229240 A1
(43) Pub. Date: Aug. 11, 2016

(54) ANTI-SKID DEVICE FOR TIRE

(71) Applicant: AUTOVOX KOREA CO., LTD., Gyeonggi-do (KR)

(72) Inventor: Dae Kyun SHIN, Hwasung-si (KR)

(21) Appl. No.: 14/784,262

(22) PCT Filed: Jul. 16, 2014
(86) PCT No.: PCT/KR2014/006450

§ 371 Date: Oct. 13, 2015

(30) Foreign Application Priority Data
Jul. 25, 2013 (KR) 10-2013-0088118

(51) Int. Cl. B60C 27/02; B60C 27/20

(52) U.S. Cl. CPC B60C 27/0269; B60C 27/023; B60C 27/20

(57) ABSTRACT

The present invention relates to an anti-skid device for a tire, comprising: fixed plates fixed to a wheel of the tire, the fixed plates each having a cylindrical nut-type fastening means with a thread formed on the inner circumferential surface in the center thereof; a supporting plate having a body part with an insertion hole formed in the center thereof and a plurality of connecting plates which are formed to radially protrude on the outer circumferential surface of the body part; anti-skid arms fixed to the connecting plates; and a locking plate for fixing the supporting plate between the fixed plates. The locking plate has a disc-shaped body between which and the fixed, plates the body past of the supporting plate is interposed, and a bolt-type fastening means which is formed to protrude on the lower surface of the disc-shaped body and which has a thread formed on the outer circumferential surface so that the bolt-type fastening means can be coupled to the nut-type fastening means in a screw fastening manner.

### TECHNICAL FIELD

The present invention relates to an anti-skid device for a tire, and more particularly, to an anti-skid device for a tire that, is mounted on a tire for stable driving on a snowy road or an icy road.

In general, chains, integrated, chains connected through a cable or a urethane block, snow tires, spike tires, and the like, are used to prevent skid of a vehicle on a snowy road or an icy road.

The chains or integrated chains are very difficult and complicated to mount became it is required to move them forward/backward m order to mount them. Even if an adult man mount them, it is very difficult to correctly mount them in a cold winter day. Accordingly, the chains are separated from a wheel and cause an accident while a vehicle is driven, or they may be damaged even into a non-reusable state.

Further, it is difficult to quickly change the snow tires or the spike tires on a mad under sudden change in weather condition, so the driver has to dangerously drive to a car mechanic to change the tires. Further, the tires are expensive and reduce fuel efficiency, so it is not economical.

Due to these defects, recently, anti-skid devices for a tire that are coupled to tires from a side have been increasing used.

FIG. 1 is art exploded perspective view illustrating a process of mounting an anti-skid device for a tire known in the art to a tire.

The anti-skid device for a tire includes a fixed plate 20 that is fixed to a wheel W of a tire T by an adapter 10, a support plate 30 that has a plurality of anti-skid arms 40, and a locking plate 50 that fixes the support plate 30 to a side of the wheel W of the tire T.

The adapter 10, which is a part coupled to a side of the wheel W of the tire T to fix the fixed plate 20 to the tire, includes a special nut 11 with nut holes 11a and 11b at both ends, a fixing clip 12 composed of a clip 12a and a cap 12b, a long nut 13 with a bolt portion 13a and a nut hole 13b at both ends, and a short nut 14 with a bolt portion 14a and a nut hole 10b at both ends.

The adapter 10 selectively couples the special nut 11 or the fixing clip 12 and selectively connects the long nut 13 or the short nut 14 to the special nut 11 or the fixing clip 12, in accordance with wheel bolts B or outs N coupled to the outer side of the wheel W.

Thereafter, the fixed plate 20 is fixed by inserting and tightening a bolt 16 into the nut hole 13b or 14b of the long nut 13 or the short nut 14 from the outside with the fixed plate 20 is disposed in position. In this process, washers 15 made of synthetic resin or metal may be interposed.

The anti-skid device is completely mounted, as described above, by mounting the support plate 30 coupled to the anti-skid arm 40 on the tire W, with the fixed plate 20 fixed to the wheel W, and coupling the locking plate 50 to the fixed plate 20 at the center of the support plate 30 so that the support plate 30 is fixed.

FIG. 2 is a cross-sectional view illustrating the coupling of the support plate 20 and the locking plate 50 in the anti-skid device for a tire illustrated in FIG. 1.

Referring to FIG. 2, the fixed plate 20 has steps 22 protruding toward the outside of a vehicle and circumferentially arranged with regular intervals around the inside of an insertion hole formed at the center portion, and has a plurality of fixing holes 25 through the plate to be coupled to tires W having various sizes by the adapter 10.

The locking plate 50 is fitted in the fixed plate 20 with the support plate 30 therebetween, has a circular protrusion 51 inserted in the insertion hole of the fixed plate 20, and has stoppers 52 that are formed around the circular protrusion 51 and are inserted into the spaces between the steps 22 of the fixed plate 20 and locked to the lower ends of the steps 22 when they are turned. Further, the locking plate 50 further has a restricting member 56 that is inserted in the center of the locking plate 50 and prevents rotation of the locking plate 50 by blocking the space between the steps 22 of the fixed plate when the locking plate 50 is turned to the fixed position.

However, when the anti-skid device is mounted in this way, the anti-skid device may be unlocked and separated from a tire while a vehicle is driven. When a vehicle equipped with the anti-skid device is driven on an uneven road, a large gap is generated between the anti-skid device and a tire, so the stoppers 52 of the locking plate 50 are damaged and the fixed plate 20 and the locking plate 50 are separated due to shock by the gap, so the anti-skid device is unlocked and separated from the wheel.

Such separation of an anti-skid device is generated while a vehicle is driven, so the separated anti-skid device interferes with the operation of the wheel, and it is likely to cause an accident.

### DISCLOSURE

### Technical Problem

The present invention has been made in an effort to solve these problems and an object of the present invention is to provide an anti-skid device for a tire that can prevent an anti-skid device for a tire from being damaged and separated by shock while a vehicle is driven.

Another object of the present invention is to pro vide an anti-skid device for a tire that can reduce shaking of an anti-skid device by fixing a support plate in close contact with a fixed plate and that can reduce vibration or noise that is generated when a vehicle equipped with an anti-skid device for a tire runs on a snowy road or an icy road.

### Technical Solution

The present invention provides an anti-skid device for a tire that is fixed to a tire of a vehicle. The device includes: a fixed plate that is fixed to a wheel of a tire, has a cylindrical nut-type fastening portion protruding toward the wheel of the tire at a center portion and having a thread on the inner side, and has a plurality of fixing holes for fixing to the wheel on the surface; a support plate having a disc body having an insertion hole at the center portion and a plurality of coupling plates protruding radially around the outer side of the body; anti-skid arras that have a fastening portion coupled to the coupling plates and a contact portion, having a plurality of spikes on the outer surface that bends at an end of the fastening portion, and comes in contact with a road surface when being fastened to the tire: and a locking plate that protrudes on the bottom of a disc body, has a bolt-type fastening portion fastened to the nut-type fastening portion, and that is fixed with the body of the support plate between the bottom of the body and the fixed plate, in which threads for fastening the locking plate to the fixed plate by turning the locking plate in a direction in which the tire is rotated to drive a vehicle forward are formed on the nut-type fastening portion and the bolt-type fastening portion.

According to the present invention, a grip for a user to hold the locking plate is formed on the top of the body of the locking plate, and a tool groove where an insertion of a tightening tool for tightening the locking plate is inserted is formed at a center portion on the top of the body of the locking plate, so a user can insert the insertion of the tightening tool into the tool groove and tighten, the locking plate by turning the tightening tool using a handle.

According to the present invention, a first prominence-depression is formed around the nut-type fastening portion on the surface of fixed plate, and a disc portion that protrudes downward, covers the bolt-type fastening portion, and has a first counter-prominence-depression that coupled to the first prominence-depression thereon is disposed on the bottom of the locking plate. Herein, the first prominence-depression is composed of a plurality of projections radially extending with regular intervals on at least a portion of a surface around the nut-type fastening portion of the fixed plate, and the first counter-prominence-depression is composed of a plurality of grooves radially extending with regular intervals on the surface of disc portion for receiving the plurality of projections of the first prominence-depression.

According to the present invention, a first prominence-depression is formed around the nut-type fastening portion on the surface of the fixed plate, and a disc portion made of an elastic material, protruding downward to cover the bolt-type fastening portion, and corresponding to the first prominence-depression is disposed on the bottom of the locking plate.

According to the present invention, second prominence-depression is formed on a surface around the insertion hole of the body of the support plate, and a second counter-prominence-depression coupled to the second prominence-depression is formed on the bottom of the body of the locking plate. Herein, the second prominence-depression is composed of a plurality of projections radially extending with regular intervals, and the second counter-prominence-depression is composed of a plurality of grooves radially extending with regular intervals on the bottom of the body for receiving the projections of the second prominence-depression.

According to the present invention, a second prominence-depression is formed on a surface around the insertion hole of the body of the support plate, and an elastic plate made of an elastic member to correspond to the second prominence-depression is disposed on the bottom of the body of the locking plate.

According to the present invention, a convex band protrudes at both edges of the inner side of the contact portion of the anti-skid arm, an anti-torsion reinforcing band is formed from the contact portion to the fastening portion at the center portion of the inner side of the contact portion between the convex bands at both sides, and a plurality of toenails protruding at predetermined distances is formed at the convex bands at both sides.

### Advantageous Effects

According to the present invention, an anti-skid device is fixed to a tire by a bolt-type fastening portion of a locking plate and a nut-type fastening portion of a fixed plate that are thread-fastened to each other. The bolt-type fastening portion can efficiently resist shock transmitted through the fixed plate, unlike stopper of locking plates of the related art, so it is possible to preclude the phenomenon that stoppers on a locking plate are damaged by shock and an anti-skid device is separated while a vehicle is driven as in the related art. Accordingly, stability is improved.

Further, according to the present invention, the locking plate can be fixed by thread-fastening to the fixed plate with a support plate therebetween. Accordingly, it is possible to reduce shaking of an anti-skid device, so it is possible to reduce vibration and noise generated while a vehicle equipped with an anti-skid device is driven on a snowy road or an icy road.

### DESCRIPTION OF DRAWINGS

FIG. 1 is an exploded perspective view illustrating a process of mounting an anti-skid device for a tire known in the art to a tire.

FIG. 2 is a cross-sectional view illustrating the coupling of a support plate and a locking plate in the anti-skid device for a tire illustrated in FIG. 1.

FIG. 3 is a perspective view when the anti-skid device, for a tire according to the present invention is mounted.

FIG. 4 is a perspective view illustrating a fixed plate of the anti-skid device for a tire according to the present invention.

FIG. 5 is a perspective view illustrating a support plate of the anti-skid device for a tire according to the present invention.

FIGS. 6 and 7 are a perspective view and a plan view rotary disc of the anti-skid device for a tire according to the present invention.

FIGS. 8 and 9 are an exploded perspective view and a cross-sectional view illustrating the coupling of a pair of coupling plates, a rotary disc, and anti-skid arms of the support plat of the anti-skid device for a tire according to the present invention.

FIGS. 10 and 11 are an exploded perspective view and a cross-sectional view illustrating the coupling of other coupling plates and the anti-skid arm of the support, plate of the anti-skid device for a tire according to the present invention.

FIGS. 12 and 13 are a perspective view and a plan view illustrating the anti-skid arm of the anti-skid device for a tire according to the present invention.

PIGS. 14 and 15 are perspective views illustrating the upper portion and the lower portion of the locking plate of the anti-skid device for a tire according to the present invention.

FIGS. 16 and 17 are a perspective view and a cross-sectional view of a fixed plate according to another embodiment of the present invention.

FIG. 18 is a perspective view illustrating a support plate according to another embodiment of the present invention.

FIGS. 19 and 20 are perspective views illustrating the upper portion and the lower portion of a locking plate according to another embodiment of the present invention.

FIG. 21 is a partial cross-sectional view illustrating an anti-skid device for a tire according to another embodiment of the present invention.

### BEST MODE

Embodiments of the present invention are described hereafter in detail with reference to the accompanying drawings.

An anti-skid device for a tire according to the present invention includes a fixed plate 200, a support plate 300, anti-skid arms 400, and a locking plate 500.

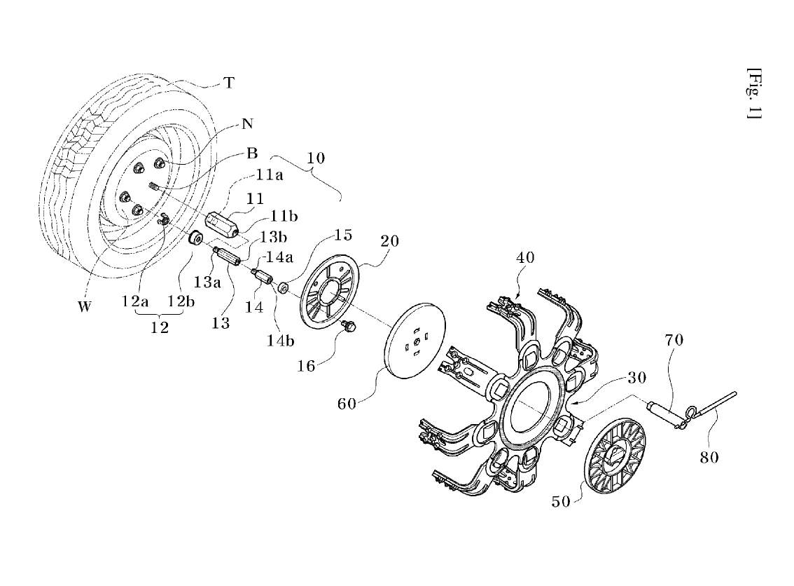

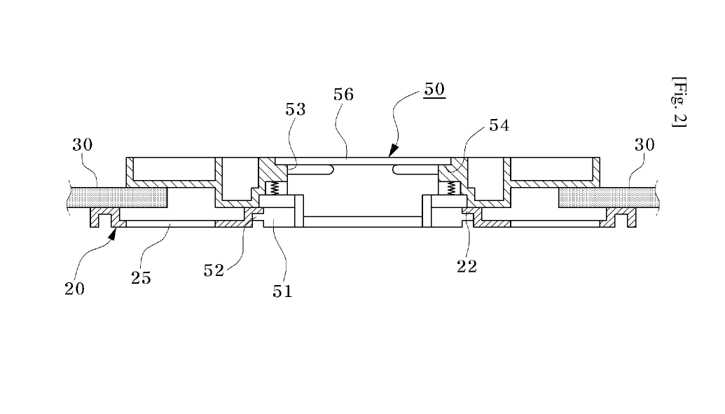

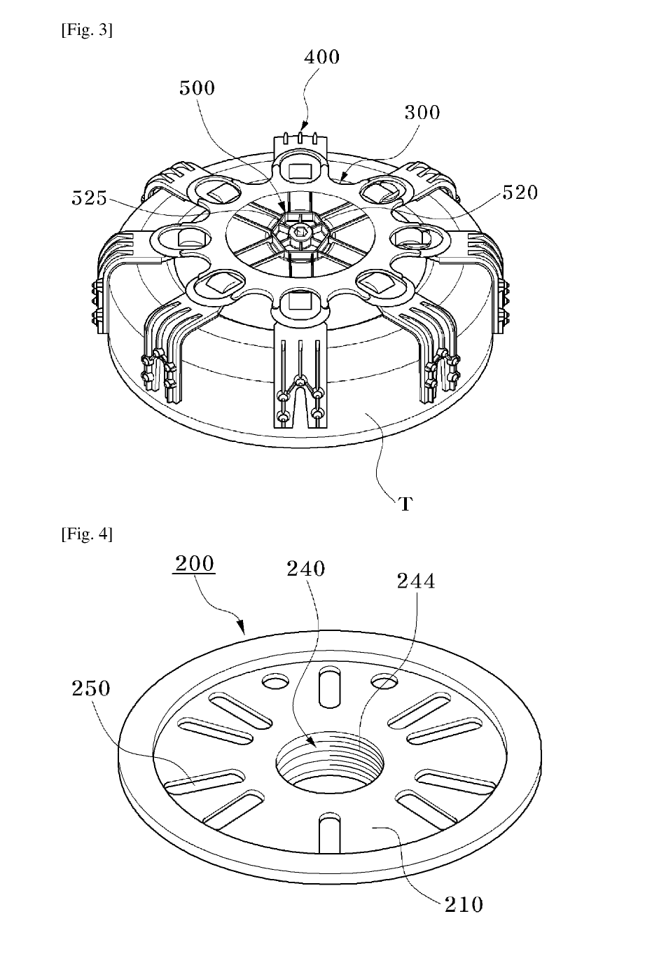

The fixed plate 200 is fixed to a wheel W of a tire T by an adapter 10 (see FIG. 1).

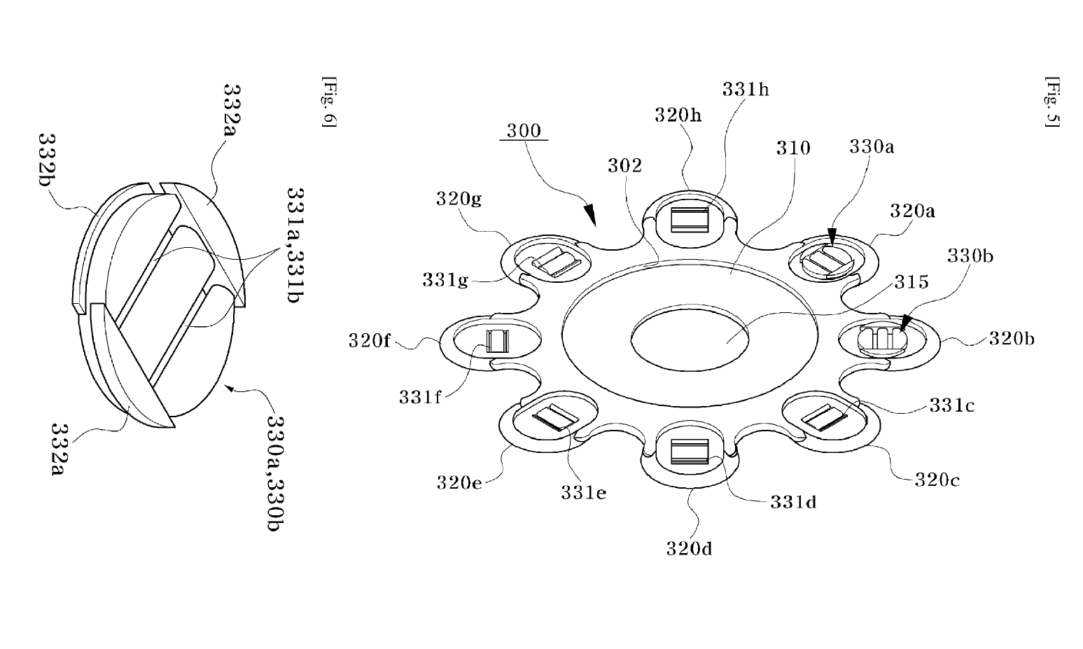

Referring to FIG. 4, the fixed plate 200 of the present invention has a cylindrical nut-shaped fastening portion 240 having a thread 244 around the inner side at the center and protruding toward a tire wheel from the center. A holt-type fastening portion 540 of the locking plate 500 is thread-fastened to the nut-type fastening portion 240 of the fixed plate 200. The fixed plate 200 is classified for a left tire or a right tire in accordance with the position of the tire where the fixed plate 200 is mounted and the thread 244 is formed on the nut-type fastening portion 240 of the fixed plate 200 so that the locking plate 500 is fastened when it is rotated in the rotational direction of the tire when a vehicle is drives forward.

A plurality of fixing holes 250 is formed through the surface 210 of the fixed plate 200. The fixing holes 250 correspond to the positions of wheel bolts on tires having various sizes when the fixed plate 200 is fixed to the wheel of a tire T by an adapter. Accordingly, the fixed plate 200 can be fixed to the wheel W of the tire T by mounting an adapter on the wheel of a tire, selectively inserting a bolt into a fixing hole 250 corresponding to the position of the adapter, and fastening the fixed plate to the adapter.

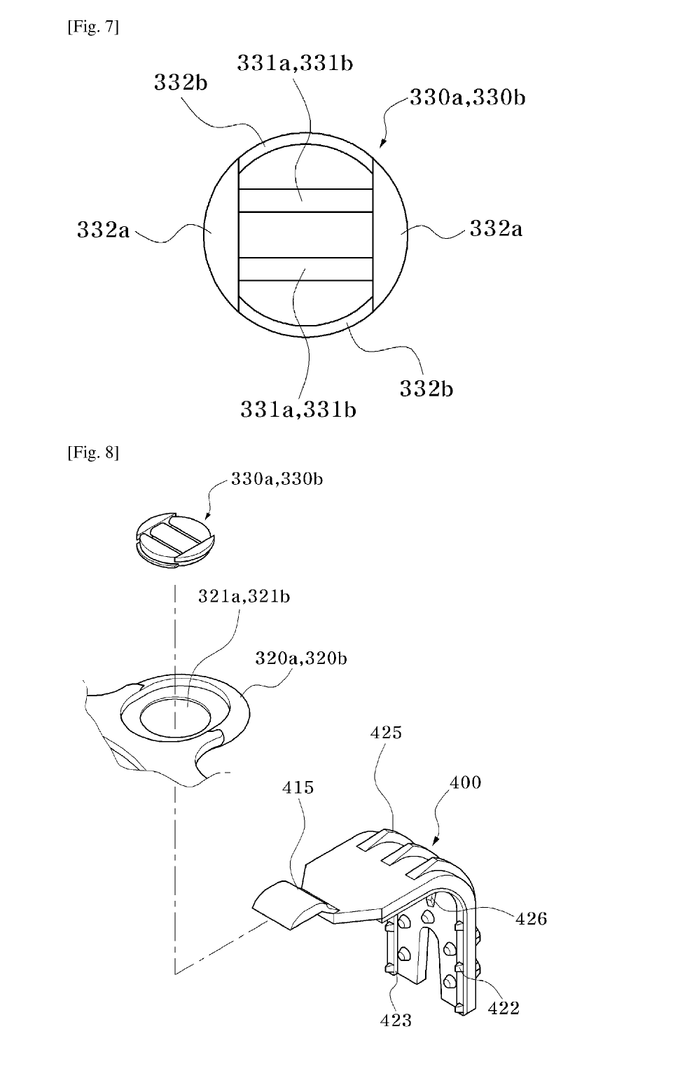

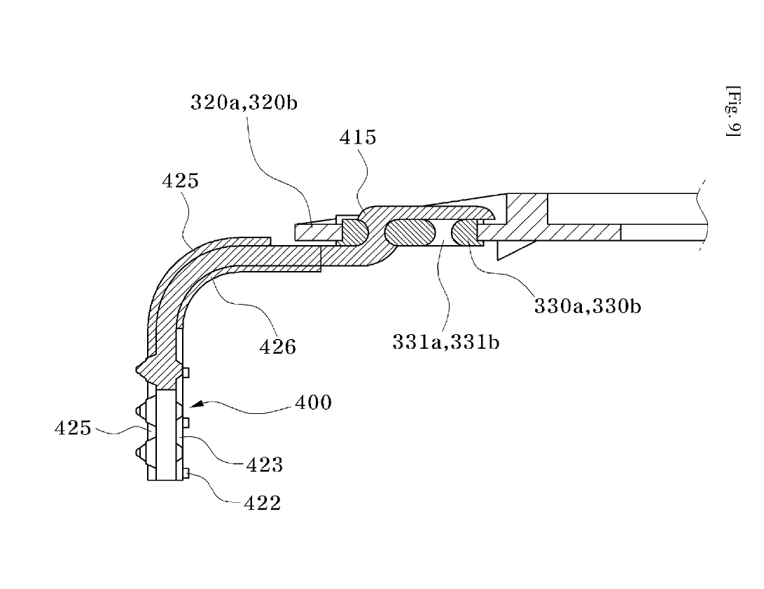

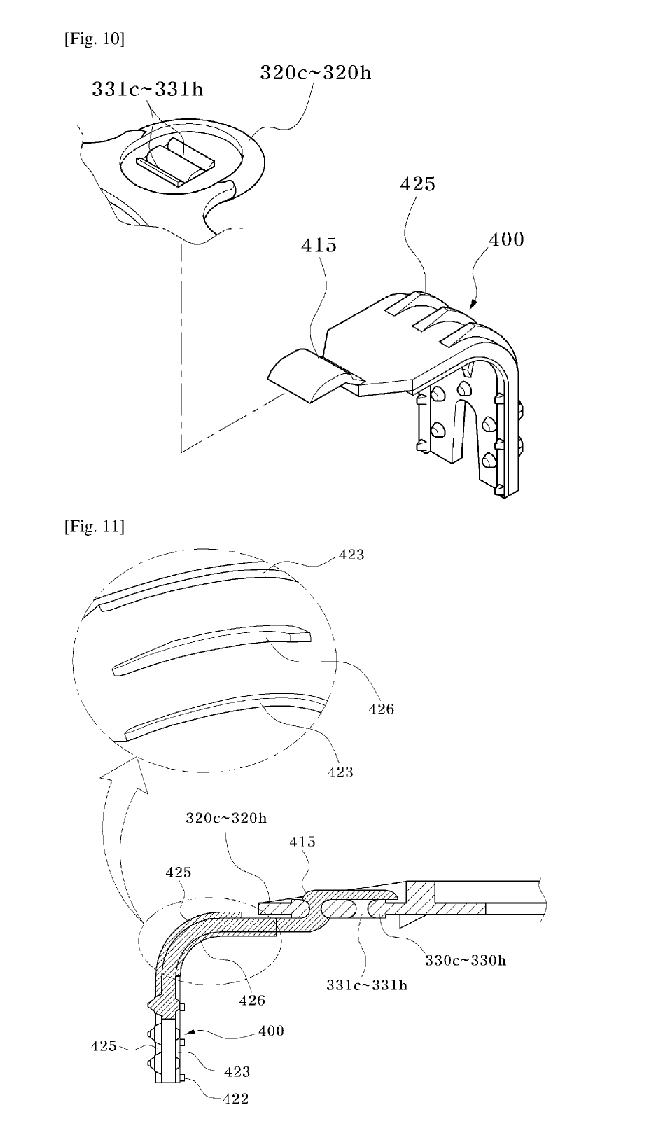

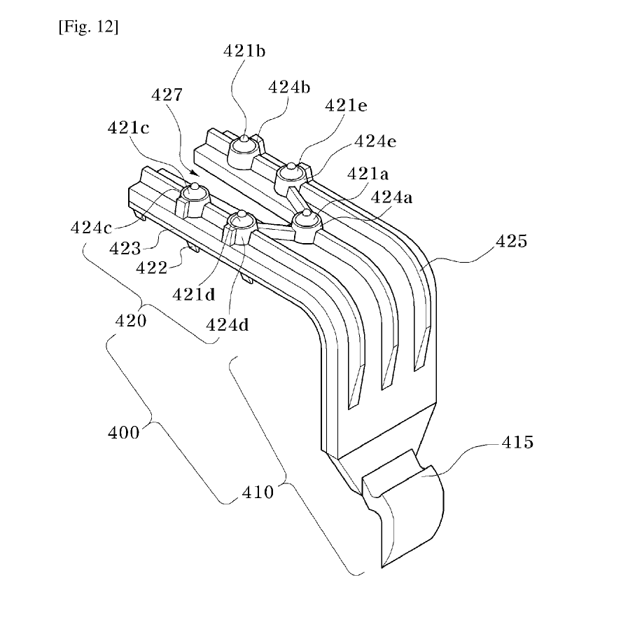

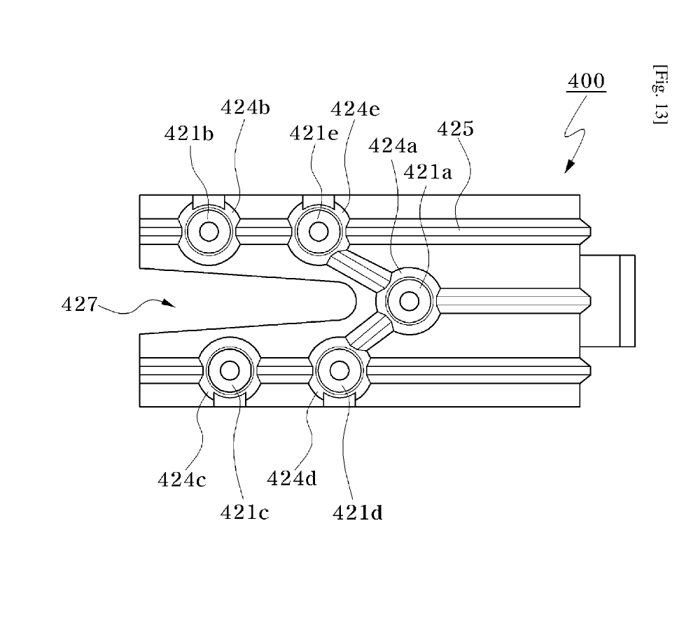

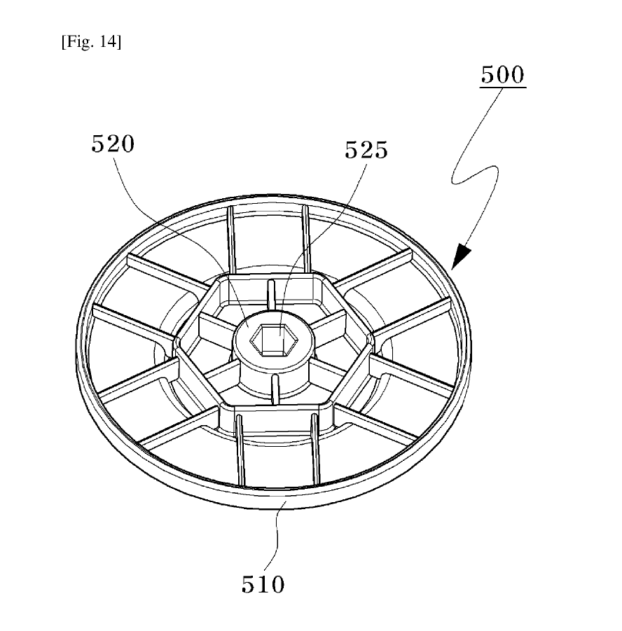

Referring to FIGS. 5 to 13, the support plate 300 according to the present invention has a disc body 310 having a surface stepped inward and extending from a ring-shaped stepped portion 302, and a plurality of coupling plates 320a and 320h protruding, radially, arranged with regular intervals around the outside of the body 310, and allowing detachable attachment of the anti-skid arms 400.

The body 310 has an insertion hole 315 at the center. The insertion hole 315 is a passage through which the bolt-type fastening portion 540 of the locking plate 500 is inserted to he fastened to the nut-type fastening portion 240 of the fixed plate 200.

The coupling plates 320a to 320h radially protrude around the outer side of the body 310 of the support plate 300. The coupling plates 320a to 320h are parts where the anti-skid arms 400 are detachably coupled, and rotation holes 321a and 321b to which the rotary discs 330a and 330b are rotatably coupled are formed through a pair of adjacent coupling plates 320a and 320b.

A plurality of fitting-adjustment holes 333c to 331h spaced with regular intervals is formed in the other coupling plates 320c to 320h except for the coupling plates 320a and 320b having the rotation holes 321a and 321b so that the ends of the anti-skid arms 400 cats be fitted.

The rotary discs 330a and 330b are rotatably disposed in the rotation holes 321a and 321b formed on the pair of adjacent coupling plates 320a and 320b and has a plurality of fitting-adjustment holes 331a and 331b spaced with regular intervals so that the ends of the anti-skid arms 400 can be fitted.

Further, upper and lower stoppers 322a and 332b alternately protruding are formed around the outer sides of the upper and lower ends of the rotary discs 330a and 330b so that, they are locked to the upper and lower sides of the coupling plates 320a and 320b to prevent separation from the rotation holes 321a and 321b.

The rotary discs 330a and 330b coupled to the anti-skid arms 400 are rotatably coupled to the pair of coupling plates 320a and 320b, so it is possible to install the anti-skid device without interference between the anti-skid arms 400 and the contact portion between the tire and the road surface by opening a pair of anti-skid arms 400 coupled to the pair of rotary plates 330a and 330b when the device is mounted on the tire.

Further, the other anti-skid arms 400 are coupled to the other coupling plates 320c to 320h without notation, so it is possible to prevent rotation of the anti-skid device for a tire with respect to the tire while a vehicle is driven on a snowy road or an icy road.

Meanwhile, since the plurality of fitting-adjustment holes 331a to 331h are formed at the other coupling plates 320c to 320h and the pair of rotary plates 330a and 330b to which, the anti-skid arms 400 are coupled, the anti-skid arms 400 can be selectively coupled to tit to the size of tires.

The anti-skid arms 400 each have a fastening portion 410 detachably coupled to the fitting-adjustment holes 331a to 331h, and a contact portion 420 vertically bending at an end of the fastening portion 410 and coming in contact with a road surface when being mounted on a tire.

The fastening portion 410 is brought in close contact with a side of a tire, and has a coupling step 415 at an end that is locked to the fitting-adjustment holes 331a to 331h when it enters a stable state after being inserted in the fitting-adjustment holes 331a to 331h.

The contact portion 420 is brought in close contact with the outer side of the tire T. A plurality of conical spikes 421a to 421d is mounted in a zigzag shape on the outer side of the contact portion 420 (on the portion coming in contact with a road surface) to increase a friction force on a snowy road, and an icy road.

The spikes 421a to 421e has a holders 424a to 424e formed on the contact portion 420 to partially cover the spikes and contact with a road surface is minimized by the conical shape of the spikes 421a to 421e, so damage to the road surface can be minimized.

Further, reinforcing ribs 425 protruding outward on the outer side of the contact portion 420 and at least partially connecting the spikes 421a to 421e are further formed to increase strength of the entire contact portion 420 and increase the friction, force on a snowy road and an icy road.

A U-shaped groove 427 is formed at the end of the contact portion 420 to improve a ground-contact force on a snowy road.

Further, a convex bands 423 that protrude may be further formed at both edges of the inner side (the portion coming in contact with the outer side of the tire) of the contact portion 420 to increase coupling force to the tire.

Further, a plurality of toenails 422 protruding and spaced each other is formed on both convex bands 423. The toenails 422 formed on both convex bands 423 allow the anti-skid arms 400 to hold the outer side of a tire, so they prevent spin between the tire and the anti-skid arms.

Meanwhile, an anti-torsion reinforcement band 426 is formed from the contact portion 420 to the fastening portion 410, at the center of the inner side of the contact portion 420 (see FIG. 11).

Referring to FIGS. 14 and 15, the locking plate 500 according to the present invention, has a disc body 510 and a bolt-type fastening portion 540 protruding on the bottom of the body 510. The bolt-type fastening portion 540 is fastened to the nut-type fastening portion 240 of the fixed plate 200.

A thread 544 is formed around the outer side of the bolt-type fastening portion 540 of the locking plate 500. The thread 544 is formed in a direction in which fastening is made when the locking plate 500 is rotated in the direction in which the tire equipped with the anti-skid device is rotated to drive a vehicle forward. When a vehicle is driven forward, the right tire is rotated clockwise and the left tire is rotated counterclockwise. Accordingly, a right thread is formed on the bolt-type fastening portion 540 of the locking plate 500 for an anti-skid device for a tire that is mounted on a right tire and a left thread is formed on the bolt-type fastening portion 540 of the locking plate 500 for an anti-skid device for a tire that is mounted on a left tire. Further, the threads 244 of the nut-type fastening portions 240 of the fixed plates 200 that are coupled to the locking plates 500 are formed in the corresponding directions.

Accordingly, it is possible to thread-fasten the holt-type fastening portion 540 of the locking plate 500 and the nut-type fastening portion 240 of the fixed plate by rotating the bolt-type fastening portion 540 of the locking plate 500 in the same direction as the rotation direction of a tire when a vehicle is driven forward.

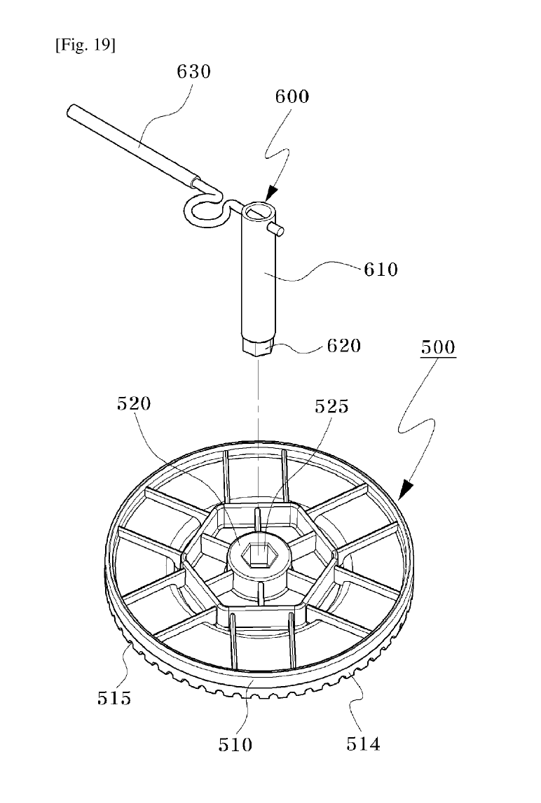

The locking plate 500 is fastened to the fixed plate 200 by a tightening tool 600 (see FIG. 19), with the support plate 300 having the anti-skid arms 400 between the locking plate and the fixed plate 200. The locking plate 500 receives a force in the locking direction by inertia every time braking is performed while a vehicle is driven forward, so the locking plate 500 can keep being coupled to the fixed plate 200 by a strong fixing force without separating while the vehicle is driven. That is, according to the present invention, by using the fact that a rapid change in speed of a tire while a vehicle is driven is made every time braking is performed while the vehicle is driven. forward, the locking plate 500 is tightened by torque in the locking direction to the fixed plate 200 by inertia in every braking, so the fixing force for the locking plate 500 can be kept strong.

A grip 520 allowing a user to hold and turn the locking plate 500 is formed on the top of the disc body 510 of the locking plate 500, and a hexagonal tool groove 525 is formed at the center portion of the disc body 510, that is, at the center portion of the grip 520. The tool groove 525 is provided for a user to fix the locking plate by strongly turning the locking plate 500, using a tightening tool 600 (see FIG. 19), after temporarily locking the locking plate 500 with a hand.

Referring to FIG. 19, the tightening tool 600 has a hexagonal insertion 620 that is inserted into the tool groove 525 at the lower end of a tool body 610, and a handle 630 extending from the side of the tool body 610. It is possible to tighten the locking plate 500 to the fixed plate 200 with the support plate 300 therebetween, by inserting the insertion 620 into the tool groove 525 and then turning the tightening tool 600 with a hand holding the handle 630 to turn the locking plate 500.

Referring to FIG. 15, a disc portion 530 protruding downward and covering the bolt-type fastening portion 540 at the center portion is disposed on the bottom of the disc body 510 of the locking plate 500. The disc portion 530 is in close contact with the top of the fixed plate 200.

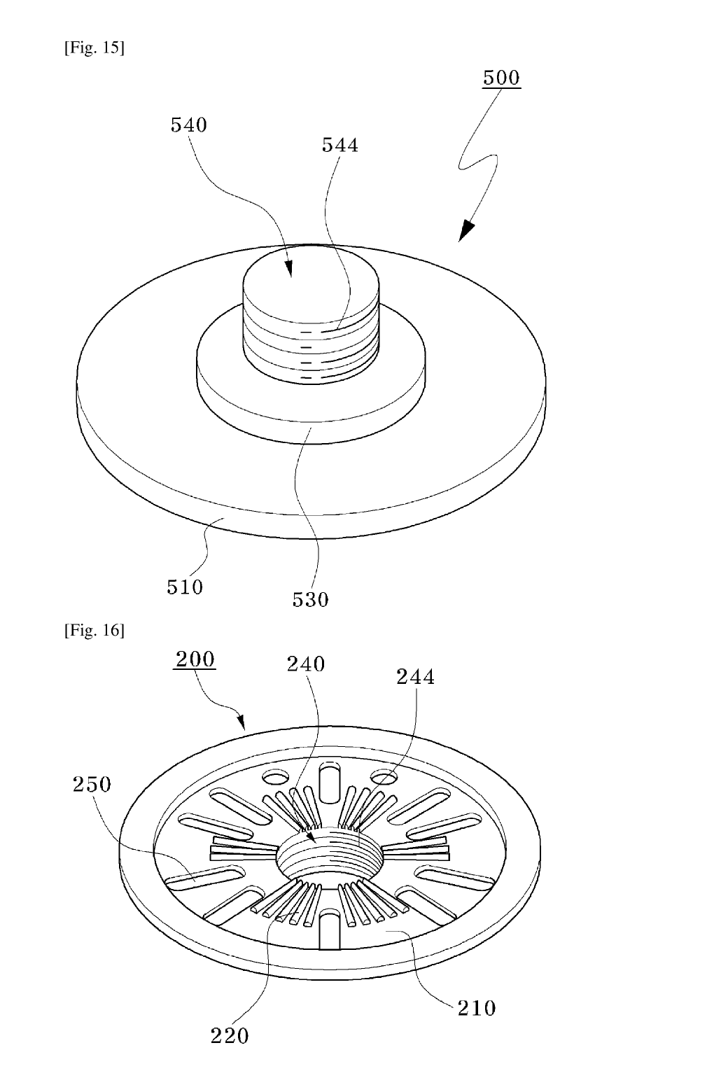

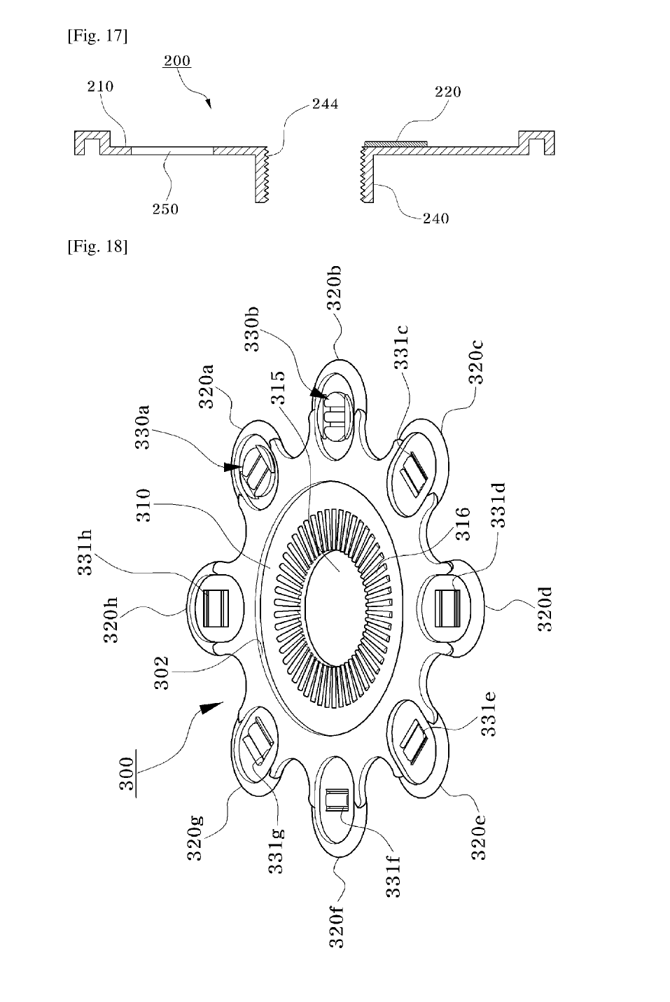

FIGS. 16 to 21 illustrate another embodiment of an anti-skid device for a tire according to the present invention, that is, illustrate another embodiment of the fixed plate 200, support plate 300, and locking plate 500.

Referring to FIGS, 16 and 17, the fixed plate 200 according to another embodiment of the present invention further includes a first prominence-depression 220 around a nut-type fastening portion 240 on the surface.

The first prominence-depression 220 may be composed of a plurality of projections extending radially with regular intervals around the nut-type fastening portion 240. Although the projections are exaggerated in the drawings for the convenience of understanding, they have a height and width that do not interfere with fixing the locking plate 500 when the locking plate 500 is locked to the fixed plate 200 by the tightening tool 600.

When the first prominence-depression 220 is composed of a plurality of projections, they may be formed only in a predetermined area on the surface around the nut-type fastening portion 240 in consideration of the position of the fixing holes 250. For example, they may be formed with regular intervals around the nut-type fastening portion 240 at positions that do not overlap the fixing holes 250.

The first prominence-depression 220 prevents the locking plate 500 from being unlocked by increasing a friction force in contact with a first counter-prominence-depression 535 of the locking plate 500.

Referring to FIG. 18, the support plate 300 according to another embodiment of the present invention further includes a second prominence-depression 316 on the surface around an insertion hole 315 of a body 310 to increase a friction force in contact with the locking plate 500.

According to another embodiment of the present invention, the second prominence-depression 316 may be composed of a plurality of projections radially extending with regular intervals around the insertion hole 315. Although the projections are exaggerated in the drawings for convenience of understanding, they have a height and width that do not interfere with fixing the support plate 300 by the locking plate 500 when the locking plate 500 is locked to the fixed plate 200 by the tightening tool 600, with a bolt fastening portion 540 of the locking plate 500 inserted in the insertion hole 315.

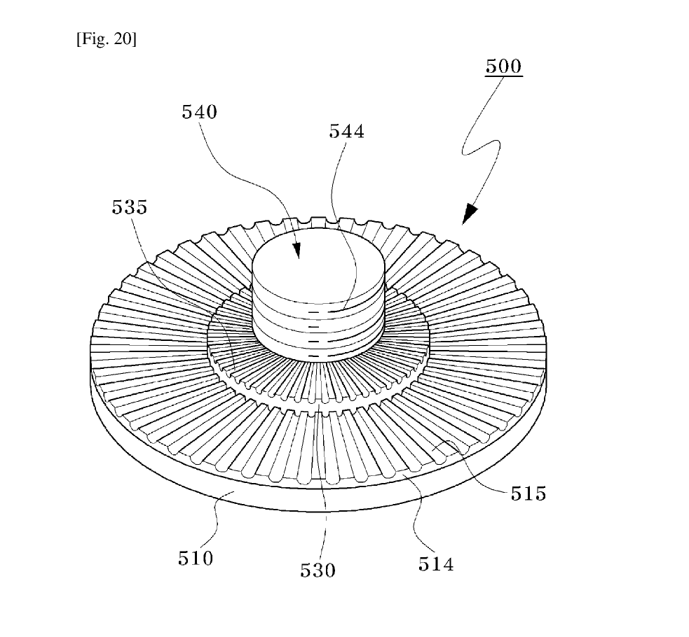

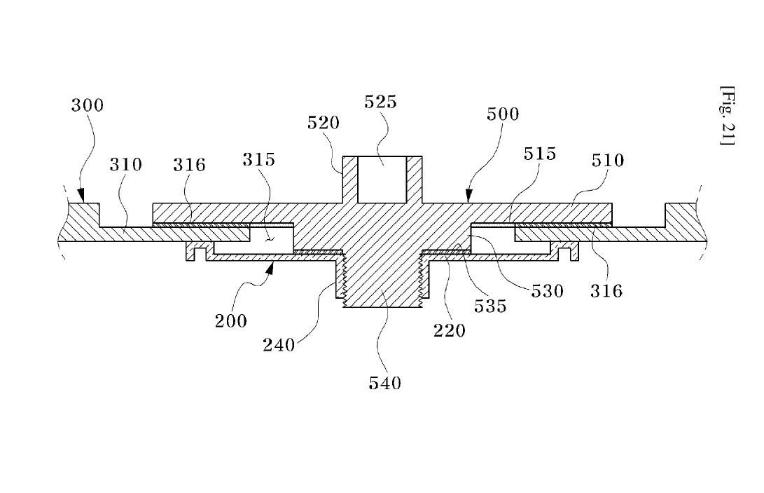

Referring to FIGS. 19 and 20, the locking plate 500 according to another embodiment of the present invention includes the first counter-prominence-depression 535 that is coupled to the first prominence-depression of the fixed plate 200, on the surface of a disc portion 530. The first counter-prominence-depression 535 prevents unlocking by increasing a friction force in contact with the first prominence-depression 220.

When the first prominence-depression 220 is composed of a plurality of projections, the first counter-prominence-depression 535 may be composed of a plurality of grooves radially formed with regular intervals to correspond to the projections.

Further, according to the present invention, the disc portion 530 may be made of an elastic material having elasticity such as rubber. When the disc portion 530 is made of an elastic material, it increases a friction force by combining with the first prominence-depression 220 by elastic deformation. In this case, the disc portion 530 may selectively have the first counter-prominence-depression 535.

A second counter-prominence-depression 515 is formed on the bottom of the disc body 510, that is, on the outer surface of the disc 530. The second counter-prominence-depression 515 prevents unlocking between the support plate 300 and the locking plate 500 by being coupled to the second prominence-depression 316 of the support plate 300.

When the second prominence-depression 316 formed on the body 310 of the support plate 300 is composed of a plurality of projections, the second counter-prominence-depression 515 may be composed of a plurality of grooves radially extending with regular intervals to correspond to the projections.

According to another embodiment of the present invention, a ring-shaped elastic plate 514 made of an elastic material such as rubber may be further disposed on the bottom of the disc body 510 where the second counter-prominence-depression 515 is formed. The elastic plate 514 is coupled to the second prominence-depression 316 to increase a friction force by elastically deforming and may selectively have the second counter-prominence-depression 515.

FIG. 21 is a cross-sectional view illustrating partial coupling of an anti-skid device for a tire according to another embodiment of the present invention. A process of installing the anti-skid device for a tire of the present invention is described with reference to FIG. 21.

First, the fixed plate 200 is fixed to a tire wheel by an adapter. The fixed plate may be mounted on a tire wheel when the anti-skid device for a tire is installed, and when there is a need for frequently install the anti-skid device for a tire in a season such as winter, a vehicle can be driven with the fixed plate fixed to a tire wheel in advance. In this case the vehicle can be driven with the fixed plate covered with a fixed cover (not illustrated) for the external appearance of the vehicle.

When it is required to drive on a snowy road or an icy road, a user separates the fixed cover from the fixed plate 200 and fits the support plate 300 coupled with a plurality of anti-skid arms 400 onto a tire, in which two anti-skid arms 400 coupled to the rotary discs 330a and 330b of the plurality of anti-skid arms 400 are brought in contact with the road surface and the device is mounted on a tire with the arms opened to both sides.

Next, the locking plate 500 is fixed to the fixed plate 200, at the outside of the support plate 300, in which the body 310 of the support plate 300 is positioned around the insertion hole 315 between the body 510 of the locking plate 500 and the fixed plate 200.

In order to fix the locking plate, a user holds the grip 520 of the locking plate 500 with a hand and turns the locking plate 500 in the fastening direction so that the bolt-type fastening portion 540 is thread-fastened to the nut-type fastening portion 240 of the fixed plate 200. Thereafter, the user inserts the insertion 620 of the tightening tool 600 into the tool groove 525, holds the handle 630, and turns the tightening tool 600 in the fastening direction of the locking plate 500, thereby more firmly combining the locking plate 500 and the fixed plate 200.

Accordingly, when a vehicle is equipped with the anti-skid device for a tire and driven on an icy road or a snowy road, the locking plate 500 continuously receives a force in the tightening direction while the vehicle is driven, so the locking plate 500 is not unlocked.

Meanwhile, the coupling between the first prominence-depression 220 of the fixed plate 200 and the first counter-prominence-depression 535 of the locking plate 500 and the coupling between the second prominence-depression 316 of the support plate 300 and the second counter-prominence-depression 515 of the locking plate 500 additionally support, each other, so the locking plate 500 can be more firmly maintained.

According to the present invention, as compared with anti-skid devices for a tire of the related art, the anti-skid device for a tire can be more firmly coupled, so vibration and noise can be reduced. Further, the coupled portions are not damaged, so it is possible to remove the danger of separation of the anti-skid device for a tire while a vehicle is driven. Therefore, stability is more improved.

Although embodiments of an anti-skid device for a tire of the present invention were described above, the present invention is not limited thereto and various changes and modification within the scope of the present invention described in claims and illustrated in the accompanying drawings should be construed as being included in the present invention.

1. An anti-skid device for a tire that is fixed to a tire of a vehicle; the device comprising:
a fixed plate that is fixed to a wheel of a tire, has a cylindrical nut-type fastening portion protruding toward the wheel of the tire at a center portion and having a thread on the inner side, and has a plurality of fixing holes for fixing to the wheel on the surface;
a support plate having a disc body having an insertion hole at the center portion and a plurality of coupling plates protruding radially around the outer side of the body;
anti-skid arms that have a fastening portion coupled to the coupling plates and a contact portion having a plurality of spikes on the outer surface that bends at an end of the fastening portion and comes in contact with a road surface when being fastened to the tire; and
a locking plate that protrudes on the bottom of a disc body, has a bolt-type fastening, portion fastened to the nut-type fastening portion, and that is fixed with the body of the support plate between the bottom of the body and the fixed plate,
wherein threads for fastening the locking plate to the Fixed plate by turning the locking plate in a direction, in which the tire is rotated to drive a vehicle forward are formed on the nut-type fastening portion and the bolt-type fastening portion.

2. The device of claim 1, wherein a tool groove where an insertion of a tightening tool for tightening the locking plate is inserted is formed at a center portion on the top of the body of the locking plate, and
a user can insert the insertion of the tightening tool into the tool groove and tighten the locking plate by turning the tightening tool using a handle.

3. The device of claim 1, wherein a first prominence-depression is formed around the nut-type fastening portion on the surface of fixed plate, and
a disc portion that protrudes downward, covers the bolt-type fastening portion, and has a first counter-prominence-depression that coupled to the first prominence-depression thereon is disposed oh she bottom of the locking plate.

4. The device of claim 3, wherein the first prominence-depression is composed of a plurality of projections radially extending with regular intervals on at least a portion of a surface around the nut-type fastening portion of the fixed plate, and
the first counter-prominence-depression is composed of a plurality of grooves radially extending with regular intervals on the surface of disc portion for receiving the plurality of projections of the first prominence-depression.

5. The device of claim 1, wherein a first prominence-depression is formed around the nut-type fastening portion on the surface of the fixed plate, and
a disc portion made of an elastic material, protruding downward to cover the tool-type fastening portion, and corresponding to the first prominence-depression is disposed on the bottom of the locking plate.

6. The device of claim 1 or 3, wherein a second prominence-depression is formed on a surface around the insertion hole of the body of the support plate, and
a second, counter-prominence-depression coupled to the second prominence-depression is formed on the bottom of the body of the locking plate.

7. The device of claim 6, wherein the second prominence-depression is composed of a plurality of projections radially extending with regular intervals, and
the second counter-prominence-depression is composed of a plurality of grooves radially extending with regular intervals on the bottom of the body for receiving the projections of the second prominence-depression.

8. The device of claim 1 or 3, wherein a second prominence-depression is formed on a surface around the insertion hole of the body of the support plate, and
an elastic plate made of an elastic member to correspond to the second prominence-depression is disposed on the bottom of the body of the locking plate.

9. The device of claim 1, wherein a convex band protrudes at both edges of the inner side of the contact portion of the anti-skid arm,
an anti-torsion reinforcing band is formed from the contact portion to the fastening portion at the center portion of the inner side of the contact portion between the convex bands at both sides, and
a plurality of toenails protruding at predetermined distances is formed at the convex bands at both sides.
